(19) United States
(12) Patent Application Publication
(10) Pub. No.: US 2004/0203818 A1
(43) Pub. Date: Oct. 14, 2004

(54) Wireless LAN (local area network) connection approach based on bandwidth

(75) Inventors: Daryl Carvis Cromer, Apex, NC (US); Philip John Jakes, Durham, NC (US); Howard Jeffrey Locker, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/112,885

(22) Filed: Mar. 29, 2002

(51) Int. Cl. H04Q 7/20

(52) U.S. Cl. 455/452.1; 455/450; 455/423

(57) ABSTRACT

Aspects for allowing a client to connect to an access point that has the greatest bandwidth in a wireless are described. The aspects include connecting a client to a first access point and determining if bandwidth of the first access point is at a predetermined level. Further included are determining if there are other access points available to the client if the bandwidth is below the predetermined level, and testing each of the other access points to find another bandwidth that is higher than the bandwidth of the first access point.

### FIELD OF THE INVENTION

The present invention relates to wireless local area networks, and more particularly to connecting to wireless local area networks based on bandwidth.

### BACKGROUND OF THE INVENTION

Wireless LANs (local area networks) are increasing in popularity and becoming accepted in enterprise networks. A wireless LAN provides a flexible communications system using electromagnetic airwaves (radio or infrared) for data transmissions and receptions. As shown by the block diagram of FIG. 1, in a typical wireless LAN configuration, a plurality of transmitter/receiver (transceiver) devices 10a-10c called access points connects to a wired network 12 from a fixed location using standard cabling. Usually, at a minimum, each of the plurality of access points 10a-10c receives, buffers, and transmits data from client devices 14a-14b, e.g., laptops, personal digital assistants, etc., configured on the wireless LAN and the wired network 12 infrastructure. The client devices 14a-14b access the wireless LAN through wireless-LAN adapters, which provide an interface between the client network operating system and the airwaves via an antenna.

In attempting to meet the user's expectation for the same level of consistency and quality of service from the wireless LANs that they are accustomed to in a traditional wired LAN, some key technical challenges need to be met. In the wired LAN, there is a dedicated link between access devices and the client device, which ensures that transmissions between the devices will occur at the prescribed data-rate. The access device is designed with FIFO and buffers to accommodate simultaneous high data rate transfer between several devices on the network.

In the case of 802.11 wireless LAN technology, however, there is a shared transmission medium between the access point and client devices. Since an access point can only be receiving data from one client device at a time, a given client device can monopolize that channel, effectively reducing throughput available to other client devices. What is needed is an automatic method of connecting to the access point that can provide the best bandwidth. The present invention addresses such a need.

### SUMMARY OF THE INVENTION

Aspects for allowing a client to connect to an access point that has the greatest bandwidth in a wireless are described. The aspects include connecting a client to a first access point and determining if bandwidth of the first access point is at a predetermined level. Further included are determining if there are other access points available to the client if the bandwidth is below the predetermined level, and testing the other access points to find another bandwidth that is higher than the bandwidth of the first access point.

Through the present invention, better performance is realized for a client device utilizing a wireless LAN by maintaining as optimal a bandwidth as possible. These and other advantages will become readily apparent from the following detailed description and accompanying drawings.

### BRIEF DESCRIPTION OF THE DRAWINGS

FIG. 1 illustrates a block diagram of a wireless LAN.

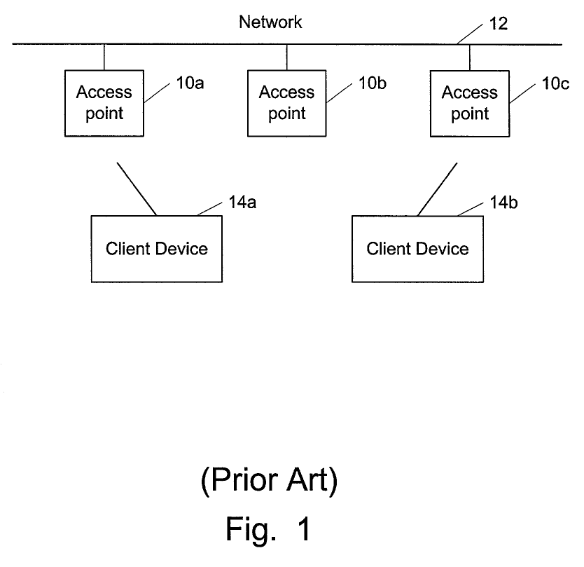

FIG. 2 illustrates a block flow diagram of a typical process for connecting to a wireless LAN.

FIG. 3 illustrates a block flow diagram of a performance routine for a connection approach based on bandwidth in accordance with the present invention.

### DETAILED DESCRIPTION OF THE INVENTION

The present invention relates to connecting to a wireless LAN based on bandwidth of available access points. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

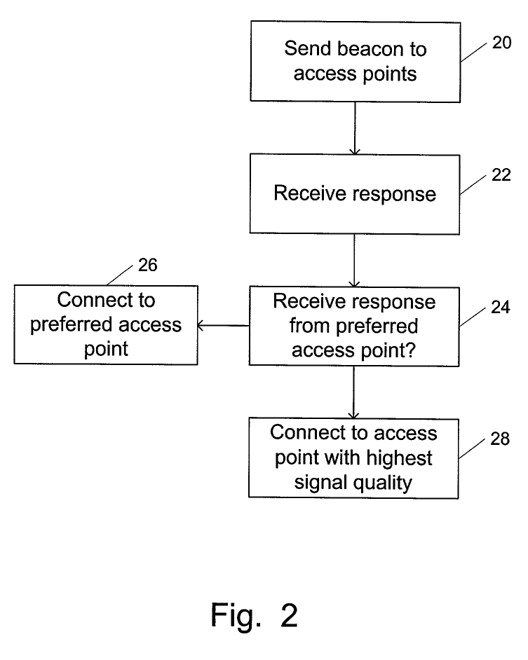

Referring to FIG. 2, a block flow diagram illustrates a typical process for connection of a client device to an access point in a wireless LAN implementation. The client device sends out a beacon (step 20), and then receive the response from the access points (step 22). The client device then determines if an access point has responded that matches one on a predetermined, preferred list in the client device (step 24). If there is a match, the client device connects to the access point that is highest on the predetermined list (step 26). If there is no match, then the client device connects to the access point with the highest signal quality (step 28). Based on connection, the client device associates and remains associated with that access point as long as the connection remains typically without further regard to signal strength.

As more client devices connect to a common access point, the access point must reduce the amount of information carried for each, thus reducing throughput for the client device up to about 91% (from about 11 megabits per second (Mbps) to about 1 Mbps). In addition, the traffic load can lead to interference, causing loss of packets and further reducing performance.

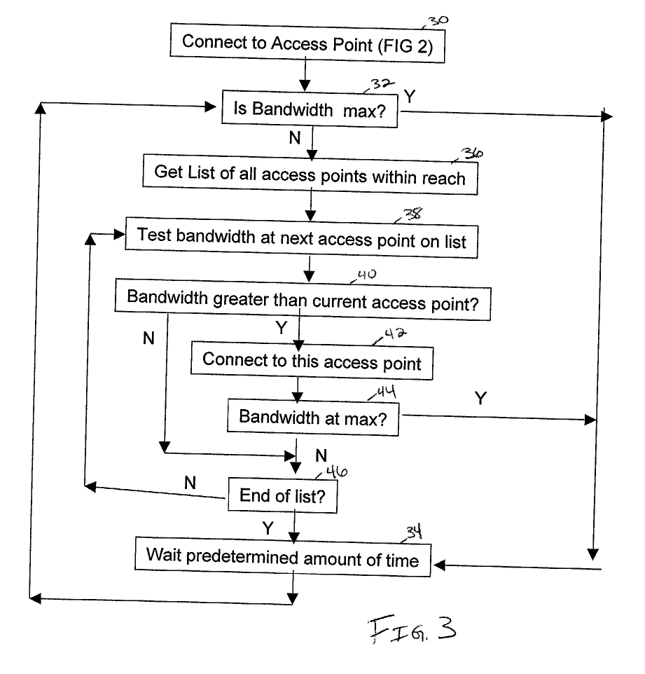

In accordance with a preferred embodiment of the present invention, client devices avoid such a reduction in performance through a performance routine of a connection approach that allows the client device to receive the greatest bandwidth in a wireless LAN, as described with reference to the block flow diagram of FIG. 3. The connection approach initiates with a client device connecting to an access point as described in FIG. 2 (step 30). Once connected, the client device then determines whether the bandwidth of the access point is at a predetermined maximum bandwidth (step 32). If it is, the client device maintains the connection to the access point and it continues to check for maintenance of the bandwidth level in the access point on a periodic basis, i.e., after waiting a predetermined period (step 34). When the bandwidth is not at the predetermined maximum bandwidth, the client device gets a list of all access points within reach for the client device (step 36). The client device tests the bandwidth of the next access point in the list (step 38). When the bandwidth is improved, as determined via step 40, the connection to that acces point commences (step 42). The bandwidth level of the access point is then checked against the predetermined maximum level (step 44). When the bandwidth is below the maximum or when the bandwidth is not greater than the current access point (i.e., step 40 is negative), a check is made to determine whether there are more access points in the list (step 46).

When there is another access point listed, the process returns to step 38 to test its bandwidth. When there are no more access points listed, the process waits the predetermined time period (step 34) and repeats the bandwidth checking from step 32. Similarly, the periodic check for maintenance of the bandwidth level occurs when the bandwidth check of step 44 is affirmative.

Through this connection approach, the present invention provides what is effectively a client-determined roaming procedure based on best bandwidth, as contrasted with cellular telephone roaming in which cell switching in the cellular network is based entirely on signal quality and not on bandwidth, i.e., a cell phone moves from one cell to the next when the signal quality of the next cell is higher than the current cell. For example, when a client device connects to a default access point and only gets 5 Mbps, it then starts the search for an access point with a better bandwidth. When it finds one at 11 Mbps, it connects to that access point. Bandwidth on this second connection then drops to 5 Mbps, so the client device starts the search again. If it cannot find one higher than 5 Mbps, it retries after the predetermined interval, which is LAN-administrator-programmable, as is well appreciated by those skilled in the art.

Thus, through the present invention, better performance is realized for a client device utilizing a wireless LAN by maintaining as optimal a bandwidth as possible. The straightforward and efficient approach of the present invention provides a substantially automatic manner of achieving roaming based on bandwidth.

From the foregoing, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

What is claimed is:

1. A method for allowing a client to connect to an access point that has the greatest bandwidth in a wireless network comprising the steps of:
(a) connecting a client to a first access point;
(b) determining if bandwidth of the first access point is at a predetermined level;
(c) determining if there are other access points available to the client if the bandwidth is below the predetermined level; and
(d) connecting the client to each of the other access points to find another bandwidth that is higher than the bandwidth of the first access point.

2. The method of claim 1 wherein when another bandwidth cannot be found, the method further comprises (e) maintaining the connection to a current access point, and (f) periodically attempting to connect to a next available access point.

3. The method of claim 2 wherein when the next available access point is found, the method further comprises (g) testing bandwidth of the next available access point and (h) determining if its bandwidth is higher than the current access point.

4. The method of claim 3 wherein when its bandwidth is higher, the method further comprises (i) connecting to the next available access point.

5. The method of claim 1 wherein when the bandwidth of the first access point is at the predetermined level, the method further comprises (b1) maintaining the connection to the first access point.

6. The method of claim 5 further comprising (b2) periodically determining whether the bandwidth is still at the predetermined level.

7. A method for allowing a client to connect to an access point that has the greatest bandwidth in a wireless network comprising the steps of:
(a) connecting a client to an access point in a wireless network; and
(b) utilizing a performance routine in the client at periodic intervals to maintain connection for the client to the wireless network at a highest available bandwidth.

8. The method of claim 7 wherein utilizing step (b) further comprises:
(b1) determining if bandwidth of the access point is at a predetermined level;
(c) determining if there are other access points available to the client if the bandwidth is below the predetermined level; and
(d) testing the other access points to find another bandwidth that is higher than the bandwidth of the access point.

9. The method of claim 8 wherein when another bandwidth cannot be found, the method further comprises (e) maintaining the connection to a current access point, and (f) periodically attempting to test for a next available access point.

10. The method of claim 9 wherein when the next available access point is found, the method further comprises (g) testing bandwidth of the next available access point, and (h) determining if its bandwidth is higher than the current access point.

11. The method of claim 10 wherein when its bandwidth is higher, the method further comprises (i) connecting to the next available access point.

12. The method of claim 8 wherein when the bandwidth of the access point is at the predetermined level, the method further comprises (b2) maintaining the connection to the access point.

13. The method of claim 12 further comprising (b3) periodically determining whether the bandwidth is still at the predetermined level.

14. A system for maintaining connections in a wireless network at best available bandwidth levels, the system comprising:
an access point; and
a client device connected to the access point wirelessly, the client device utilizing a performance routine at periodic intervals to maintain connection for the client device to the wireless network at a highest available bandwidth.

15. The system of claim 14 wherein the client device further:
(a) determines if bandwidth of the access point is at a predetermined level;
(b) determines if there are other access points available to the client if the bandwidth is below the predetermined level; and
(c) tests the other access points to find another bandwidth that is higher than the bandwidth of the access point.

16. The system of claim 15 wherein when another bandwidth cannot be found, the client device further (d) maintains the connection to a current access point, and (e) periodically attempts to test for a next available access point.

17. The system of claim 16 wherein when the next available access point is found, the client device further (f) checks bandwidth of the next available access point and (g) determines if its bandwidth is higher than the current access point.

18. The system of claim 17 wherein when its bandwidth is higher, the client device further (h) connects to the next available access point.

19. The system of claim 15 wherein when the bandwidth of the access point is at the predetermined level, the client device further (a1) maintains the connection to the access point.

20. The system of claim 19 wherein the client device further (d) periodically determines whether the bandwidth is still at the predetermined level.

21. A computer readable medium containing program instructions for allowing a client to connect to an access point that has the greatest bandwidth in a wireless network, the program instructions comprising the steps of:
(a) connecting a client to a first access point;
(b) determining if bandwidth of the first access point is at a predetermined level;
(c) determining if there are other access points available to the client if the bandwidth is below the predetermined level; and
(d) testing the other access points to find another bandwidth that is higher than the bandwidth of the first access point.

22. The computer readable medium of claim 21 wherein when another bandwidth cannot be found, the method further comprises (e) maintaining the connection to a current access point, and (f) periodically attempting to test for a next available access point.

23. The computer readable medium of claim 22 wherein when the next available access point is found, the method further comprises (g) checking bandwidth of the next available access point and (h) determining if its bandwidth is higher than the current access point.

24. The computer readable medium of claim 23 wherein when its bandwidth is higher, the method further comprises (i) connecting to the next available access point.

25. The computer readable medium of claim 21 wherein when the bandwidth of the first access point is at the predetermined level, the method further comprises (b1) maintaining the connection to the first access point.

26. The computer readable medium of claim 25 further comprising (b2) periodically determining whether the bandwidth is still at the predetermined level.
